(19) United States
(12) Patent Application Publication
(10) Pub. No.: US 2025/0244470 A1
(43) Pub. Date: Jul. 31, 2025

(54) POSITIONING METHOD, APPARATUS, ELECTRONIC DEVICE AND STORAGE MEDIUM

(71) Applicant: SAMSUNG ELECTRONICS CO., LTD., Suwon-si (KR)

(72) Inventors: Yurong PU, Suwon-si (KR); Yi GUO, Suwon-si (KR); Yohan KIM, Suwon-si (KR)

(73) Assignee: SAMSUNG ELECTRONICS CO., LTD., Suwon-si (KR)

(21) Appl. No.: 18/949,330

(22) Filed: Nov. 15, 2024

(30) Foreign Application Priority Data
Jan. 25, 2024 (KR) 10-2024-0011580

(51) Int. Cl. G01S 13/87

(52) U.S. Cl. CPC G01S 13/876

(57) ABSTRACT

A positioning method includes: acquiring a signal arrival time difference, wherein the signal arrival time difference is a time difference between a response arrival time stamp at which a response signal transmitted by a responder positioning anchor reaches a target tag, and an initial arrival time stamp at which an initial signal transmitted by an initial positioning anchor reaches the target tag, and wherein the response signal is a signal generated to respond the initial signal by the responder positioning anchor after receiving the initial signal; acquiring, based on the signal arrival time difference, initial position coordinates of a target position at which the target tag is located; and obtaining final position coordinates of the target position based on the initial position coordinates, position coordinates of the initial positioning anchor and position coordinates of the responder positioning anchor.

### CROSS-REFERENCE TO RELATED APPLICATION

This application is based on and claims priority under 35 U.S.C. § 119 to Korean Patent Application No. 10-2024-0011580, filed on Jan. 25, 2024, in the Korean Intellectual Property Office, the disclosure of which is incorporated by reference herein in its entirety.

### BACKGROUND

### 1. Field

The disclosure relates to a computer technology field, and in particular, to a positioning method, an apparatus, an electronic device and a storage medium.

### 2. Description of Related Art

In the field of positioning, Ultra-WideBand (UWB) signals may be used for target positioning. In related techniques, parameters such as a time of arrival (ToA), a time difference of arrival (TDoA), and an angle of arrival (AoA) of the UWB signals may be used to determine positional coordinates of the positioning target.

In related techniques, positional coordinates of a positioning target may be determined by using parameters such as a time of arrival (ToA), a time difference of arrival (TDoA), and an angle of arrival (AoA) of an ultra-wideband signal. A positioning algorithm based on an uplink arrival time difference makes a hyperbola with a positioning anchor as a focus and a distance difference as a long axis by measuring time differences of the ultra-wideband signal arriving at different positioning anchors. Then, an intersection of two hyperbolas made based on arrival time differences of three positioning anchors is determined as an estimated position of a positioning tag. Among them, the above positioning algorithms mainly include the following ones:

1. Chan algorithm: Chan algorithm is a non-iterative method, the position of the positioning tag is obtained based on mathematical calculation, this algorithm does not need to rely on an initial point.

2. Taylor algorithm: Taylor algorithm is an iterative algorithm. This algorithm starts iterating from an initial point, and estimates an error of a tag position by Taylor expansion, a position of the positioning tag is output when the iteration is carried out such that the error is in an acceptable range.

3. Fusion algorithm (combination) of Chan algorithm and Taylor algorithm. The position of the positioning tag is acquired by combining Chan algorithm and Taylor algorithm.

However, the positioning method based on the arrival time of the ultra-wideband signal requires time synchronization between the positioning anchors and between the positioning anchor and the positioning target; the positioning method based on the arrival time difference of the ultra-wideband signal requires time synchronization between all the positioning anchors. Moreover, if the time synchronization is performed using a wired method, wiring is required between different positioning anchors, which increases the cost of system deployment; if the time synchronization is performed using a wireless method, additional overhead of signal transmission is added.

The calculation of Chan algorithm may only contain data from three positioning anchors, and different sets of positioning anchors will get different solutions. When there are more than 3 positioning anchors in the positioning system, Chan algorithm cannot obtain more accurate results by using more information, and in some cases, the mathematical formulation of Chan algorithm may have no solution.

Taylor algorithm needs to iterate, and the iteration using different initial points will lead to different results, which will affect the positioning accuracy of the output result. Moreover, under certain conditions, Taylor algorithm may miss an optimal solution and fail to obtain a converged result.

Fusion algorithm (combination) of Chan algorithm and Taylor algorithm in the related technology only combines Chan algorithm and Taylor algorithm, and does not solve the inherent problems of Chan algorithm and Taylor algorithm.

### SUMMARY

Provided are a positioning method, an apparatus, an electronic device and a storage medium, in order to at least solve the problem in the related art that the positioning method based on ultra-wideband signals requires time synchronization, which may increase the cost of system deployment and add additional overhead of signal transmission.

According to an aspect of the disclosure, a positioning method includes: acquiring a signal arrival time difference, wherein the signal arrival time difference is a time difference between a response arrival time stamp at which a response signal transmitted by a responder positioning anchor reaches a target tag, and an initial arrival time stamp at which an initial signal transmitted by an initial positioning anchor reaches the target tag, and wherein the response signal is a signal generated to respond the initial signal by the responder positioning anchor after receiving the initial signal; acquiring, based on the signal arrival time difference, initial position coordinates of a target position at which the target tag is located; and obtaining final position coordinates of the target position based on the initial position coordinates, position coordinates of the initial positioning anchor and position coordinates of the responder positioning anchor.

According to an aspect of the disclosure, a positioning apparatus includes: a signal arrival time difference acquisition module configured to acquire a signal arrival time difference, wherein the signal arrival time difference is a time difference between a response arrival time stamp at which a response signal transmitted by a responder positioning anchor reaches a target tag, and an initial arrival time stamp at which an initial signal transmitted by an initial positioning anchor reaches the target tag, and wherein the response signal is generated to respond the initial signal by the responder positioning anchor after receiving the initial signal; an initial position coordinate acquisition module configured to acquire, based on the signal arrival time difference, initial position coordinates of a target position at which the target tag is located; and a final position coordinate acquisition module configured to obtain final position coordinates of the target position based on the initial position coordinates, position coordinates of the initial positioning anchor and position coordinates of the responder positioning anchor.

Both the foregoing general description and the following detailed description are exemplary and explanatory only and are not restrictive of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 illustrates a positioning method according to an exemplary embodiment of the disclosure;

FIG. 2 illustrates an example calculation of a signal arrival time difference α according to an exemplary embodiment of the disclosure;

FIG. 3 illustrates relative positions of a positioning anchor and a test point according to an exemplary embodiment of the disclosure;

FIG. 4 illustrates a positioning result according to an exemplary embodiment of the disclosure;

FIG. 5 illustrates a comparison of positioning indicators of a positioning method of the disclosure with other positioning methods;

FIG. 6 illustrates a specific implementation of a positioning method according to an exemplary embodiment of the disclosure;

FIG. 7 illustrates a positioning apparatus according to an exemplary embodiment of the disclosure; and

FIG. 8 illustrates an electronic device according to an exemplary embodiment of the disclosure.

### DETAILED DESCRIPTION

In order to make those skilled in the art better understand the technical solutions of the disclosure, the technical solutions in the embodiments of the disclosure will be clearly and completely described below with reference to the accompanying drawings.

The terms “first”, “second” and the like in the description and claims of the disclosure and the above drawings are used to distinguish similar objects, and are not necessarily used to describe a specific order or sequence. The data used in this way may be interchanged under appropriate circumstances so that the embodiments of the disclosure described herein can be practiced in orders other than those illustrated or described herein. The implementations described in the following examples are not intended to represent all implementations consistent with the disclosure. Rather, they are merely examples of apparatus and methods consistent with some aspects of the disclosure, as recited in the appended claims.

In the disclosure, “at least one of several items” means including three parallel situations of “any one of the several items”, “a combination of any of the several items”, “the whole of the several items”. The term “couple” and the derivatives thereof refer to any direct or indirect communication between two or more elements, whether or not those elements are in physical contact with each other. The terms “transmit”, “receive”, and “communicate” as well as the derivatives thereof encompass both direct and indirect communication. The terms “include” and “comprise”, and the derivatives thereof refer to inclusion without limitation. The term “or” is an inclusive term meaning “and/or”. The phrase “associated with,” as well as derivatives thereof, refer to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” refers to any device, system, or part thereof that controls at least one operation. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of A, B, and C” includes any of the following combinations: A, B, C, A and B, A and C, B and C, and A and B and C, and any variations thereof. As an additional example, the expression “at least one of a, b, or c” may indicate only a, only b, only c, both a and b, both a and c, both b and c, all of a, b, and c, or variations thereof. Similarly, the term “set” means one or more. Accordingly, the set of items may be a single item or a collection of two or more items.

In order to solve the problems in the related technologies, the disclosure provides a positioning method, apparatus, electronic device, and storage medium, which may first obtain initial position coordinates of a target tag based on a signal arrival time difference, and then may obtain final position coordinates of the target tag based on the calculation of the initial position coordinates and relevant parameters. That is, the disclosure does not require the time synchronization between the positioning anchors and between the positioning anchor and positioning target, which reduces the cost of system deployment and avoids additional overhead of signal transmission. Moreover, by means of iterative calculation, a gradual approximation of the optimal solution of the position coordinates may be realized, which may ensure the accuracy and precision of the positioning.

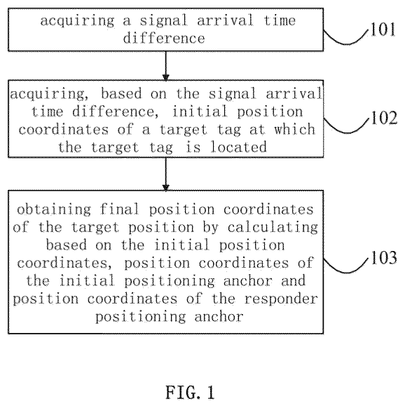

FIG. 1 illustrates a positioning method according to an exemplary embodiment of the disclosure. A positioning system of the disclosure may include an initial positioning anchor, a responder positioning anchor, and a target tag.

In some embodiments, the target tag may also be referred to as a positioning tag, and the positioning tag may be any movable device, for example, it may be a smartphone, a sports bracelet, a tablet computer, and the like. Moreover, the positioning tag may be provided with a processor chip within which specific positioning logic is stored. In some embodiments, the processor chip may be an ultra-wideband chip.

A user may deploy the positioning anchor in different positions according to his or her needs. For example, the positioning anchor may be deployed in different positioning scenarios such as around a parking lot, in a desert, in a field, and the like. Moreover, after the positioning anchor is deployed, during an actual positioning process, i.e., during the positioning method of the disclosure is performed, the position of the positioning anchor is fixed, i.e., it may be always maintained at the position where it was initially deployed.

Referring to FIG. 1, in operation 101, a signal arrival time difference may be acquired. The signal arrival time difference may be a time difference between a response arrival time stamp at which a response signal transmitted by the responder positioning anchor reaches the target tag and an initial arrival time stamp at which an initial signal transmitted by the initial positioning anchor reaches the target tag. The response signal may be a signal generated to respond the initial signal by the responder positioning anchor after receiving the initial signal.

In some embodiments, a number of initial positioning anchors may be set to 1 and may be represented by o. A number of responder positioning anchors may be set to 4, they are a responder positioning anchor m, a responder positioning anchor n, a responder positioning anchor p, and a responder positioning anchor q, respectively. The initial positioning anchor may periodically transmit an initial signal, i.e., it may transmit an ultra-wideband signal at a preset time interval. The preset time interval may be set arbitrarily according to actual needs.

After the initial positioning anchor transmits the ultra-wideband signal once, the target tag may receive the ultra-wideband signal and may obtain an initial arrival time stamp of the ultra-wideband signal arriving at the target tag. Moreover, each of the four responder positioning anchors may also receive the ultra-wideband signal, and each responder positioning anchor may transmit a response signal after a certain delay in receiving the ultra-wideband signal. At this time, the target tag may receive four response signals transmitted by each of the four responder positioning anchors, and may obtain a response arrival time stamp of each of the four response signals arriving at the target tag.

Next, the target tag may obtain a time difference between the response arrival timestamp of each of the four response signals and the initial arrival timestamp of the initial signal, i.e., it may obtain four signal arrival time differences. When these four signal arrival time differences are a signal arrival time difference αₘ, a signal arrival time difference αₙ, a signal arrival time difference αₚ, a signal arrival time difference α_{g}, respectively, these four signal arrival time differences may generate six sets of signal arrival time differences, which are (αₘ; αₙ), (αₘ; αₚ), (αₘ; α_{q}), (αₙ; αₚ), (αₙ; α_{q}), (αₚ; α_{q}).

In operation 102, initial position coordinates of a target position at which the target tag is located may be acquired based on the signal arrival time difference.

Further, the signal arrival time difference may be expressed by the following formula:

$$α = \{ ( \frac{{l}_{initial positioning anchor \cdot responder positioning anchor}}{C} + β + \frac{{d}_{positioning terminal \cdot responder positioning anchor}}{C} ) - \frac{{d}_{positioning terminal \cdot initial positioning anchor}}{C} \} = \{ ( \frac{\sqrt{\begin{matrix}{( {x}_{initial positioning anchor} - {x}_{responder positioning anchor} )}^{2} + \\ {( {y}_{initial positioning anchor} - {y}_{responder positioning anchor} )}^{2}\end{matrix}}}{C} + β + \frac{\sqrt{\begin{matrix}{( x - {x}_{responder positioning anchor} )}^{2} + \\ {( y - {y}_{responder positioning anchor} )}^{2}\end{matrix}}}{C} ) - \frac{\sqrt{\begin{matrix}{( x - {x}_{initial positioning anchor} )}^{2} + \\ {( y - {y}_{initial positioning anchor} )}^{2}\end{matrix}}}{C} \}$$

Here, α is the signal arrival time difference, C is the speed of light, β is a corresponding response delay of the responder positioning anchor, i.e., β is used to indicate how long it takes for the corresponding responder positioning anchor to transmit the response signal from the reception of the initial signal, d_{positioning terminal}, _{initial positioning anchor} denotes a distance between the positioning tag and the initial positioning anchor, d_{positioning terminal}, _{responder positioning anchor} denotes a distance between the positioning tag and the responder positioning anchor, and l_{initial positioning anchor}, _{responder positioning anchor} denotes a distance between the initial positioning anchor and the responder positioning anchor.

As mentioned earlier, in the actual positioning process, the position of the positioning anchor is fixed and will be maintained at the position where it was initially deployed, i.e., the position coordinates of the initial positioning anchor (x_{initail positioning anchor}, y_{initail positioning anchor}) and the position coordinates of the responder positioning anchor (x_{responder positioning anchor}, y_{responder positioning anchor}) are both fixed and known constants. At this point, in the formula for the signal arrival time difference α, β, C, l_{initial positioning anchor}, _{responder positioning anchor}, the position coordinates of the initial positioning anchor (x_{initail positioning anchor}, y_{initail positioning anchor}) and the position coordinates of the responder positioning anchor (x_{responder positioning anchor}, y_{responder positioning anchor}) are all known variables, and only the initial position coordinates of the positioning tag (x, y) are unknown variables, i.e., there are only two unknown variables of x and y to be solved. Therefore, only two signal arrival time differences a are needed to find the initial position coordinates (x, y) of the positioning tag.

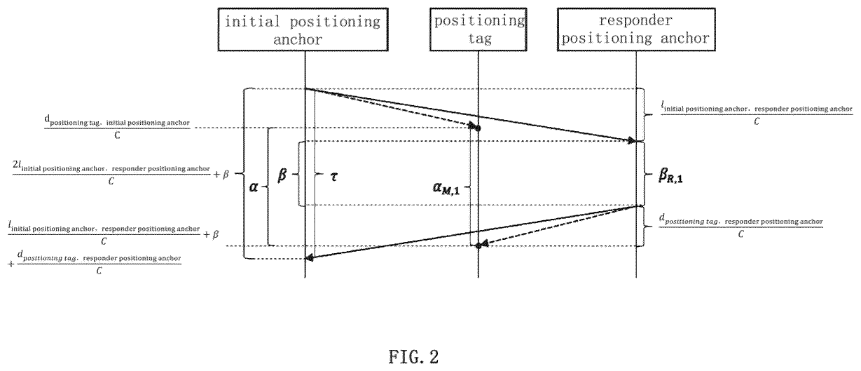

FIG. 2 illustrates an example calculation of a signal arrival time difference α according to an exemplary embodiment of the disclosure. Referring to FIG. 2, an initial positioning anchor, a positioning tag, and a responder positioning anchor are illustrated. α_{M,1} denotes a time difference between a response arrival timestamp at which the positioning tag receives a response signal transmitted by a responder positioning anchor numbered 1 for the Mth time and an initial arrival timestamp at which the positioning tag receives an initial signal transmitted by the initial positioning anchor for the Mth time; β_{R,1} denotes a response time delay corresponding to a response signal transmitted by the responder positioning anchor numbered 1 for the R^{th} time; t denotes a time difference between a time stamp at which the initial positioning anchor receives a response signal transmitted by the responder positioning anchor and a time stamp at which the initial positioning anchor transmits an initial signal.

According to an exemplary embodiment of the disclosure, the signal arrival time difference may include a plurality of signal arrival time differences. In some embodiments, as previously described, When a total of 4 responder positioning anchors exist, 4 signal arrival time differences will be obtained accordingly, respectively, the signal arrival time difference αₘ, the signal arrival time difference αₙ, the signal arrival time difference αₚ, the signal arrival time difference α_{g}. The initial position coordinates may be obtained in an iterative way based on the plurality of signal arrival time differences. In some embodiments, the initial position coordinates (x, y) of the positioning tag may be obtained in the iterative way based on four signal arrival time differences.

For each iterative process, the following operations may be performed:

A set of signal arrival time differences corresponding to a start of the current iteration can be determined. The set of signal arrival time differences is one of a plurality of sets of signal arrival time differences obtained by combining any two of the plurality of signal arrival time differences. In some embodiments, the set of signal arrival time differences corresponding to the start of the current iteration may be determined to be (αₘ; αₙ), and the set of signal arrival time differences (αₘ; αₙ) is one of the six sets of signal arrival time differences (αₘ; αₙ), (αₘ; αₚ), (αₘ; α_{q}), (αₙ; αₚ), (αₙ; α_{q}), (αₚ; α_{q}).

Then, temporary position coordinates of the target position may be acquired based on two signal arrival time differences contained in the set of the corresponding signal arrival time differences at the start of the current iteration. In some embodiments, the temporary position coordinates of the target position may be obtained based on the set of the signal arrival time differences (αₘ; αₙ) corresponding to the start of the current iteration, the position coordinates (xₒ; yₒ) of the initial positioning anchor o, the position coordinates (xₘ; yₘ) of the responder positioning anchor m, the response delay βₘ corresponding to the responder positioning anchor m, the position coordinates (xₙ; yₙ) of the responder positioning anchor n, the response delay βₙ corresponding to the responder positioning anchor n.

Next, estimated position coordinates corresponding to the current iteration may be acquired based on the initial arrival time stamp, a historical initial arrival time stamp, a preset moving speed, and historical final position coordinates. The historical initial arrival time stamp is a time stamp of a (last) historical initial signal arriving at the target tag before the initial signal arrives at the target tag, and the historical final position coordinates are coordinates of a position at which the target tag is located during the course of history that are acquired based on the historical initial signal.

Then, it may be determined whether the iterative process is terminated based on the temporary position coordinates and the estimated position coordinates corresponding to the current iteration. The temporary position coordinates obtained when the iteration is terminated may be determined as the initial position coordinates. In this way, the initial position coordinates may be calculated in the iterative way, i.e., the set of positioning anchors may be adaptively selected, i.e., the initial position coordinates may be calculated by using a greater number of signal arrival time differences, the accuracy of the calculation of the initial position coordinates may be corrected, and the problem that the mathematical formula of Chan algorithm may be unsolvable in some cases may be solved.

According to an exemplary embodiment of the disclosure, a timestamp difference value between an initial arrival timestamp and a historical initial arrival timestamp may be determined. In some embodiments, the initial positioning anchor may periodically transmit an initial signal, and the positioning tag may determine a time difference between the initial arrival timestamp of the current received initial signal (i.e., the timestamp of the initial signal transmitted by the initial positioning anchor arriving at the positioning tag this time) and the historical initial arrival timestamp of the historical initial signal received prior to this time (i.e., the time stamp of the initial signal transmitted by the initial positioning anchor arriving at the positioning tag last time) based on the initial arrival timestamp and the historical initial arrival timestamp.

Then, a moving distance of the target tag may be estimated based on the time stamp difference value and the preset moving speed. That is, an approximate distance moved by the target tag within the time interval between two initial signals may be estimated based on the time difference between the two received initial signals and the pre-stored moving speed of the positioning target.

Next, the estimated position coordinates corresponding to the current iteration may be determined based on the above moving distance and the historical final position coordinates. That is, an approximate position to which the positioning target is moved when the initial signal is received this time may be estimated based on the estimated approximate distance moved by the positioning target within the time interval between the two received initial signals and the final position coordinates of the positioning target determined last time.

Further, in different scenarios, the preset moving speed may be different. For example, in a scenario in which the positioning is performed for a car, the preset moving speed is a normal traveling speed of the car, which may be set relatively large; in a scenario in which the positioning is performed for a natural person, the preset moving speed is a normal walking speed of the natural person, which may be set relatively small. It can be seen that the preset moving speed in different scenarios is related to a type of a positioning target in the scenario. In this way, the disclosure may provide a feedback mechanism that may feed the current positioning result into the next positioning calculation, forming a closed-loop feedback system that may improve the overall positioning accuracy.

According to an exemplary embodiment of the disclosure, in a case where an absolute value of a difference value between the temporary position coordinates and the estimated position coordinates corresponding to the current iteration is less than or equal to a preset first threshold, the case indicates that the temporary position of the positioning target obtained in the current iteration is closer to the approximate position to which the positioning target may be moved estimated based on the historical position and the moving law of the positioning target, and at this time, it may be considered that the temporary position of the positioning target obtained in the current iteration is more accurate. Therefore, the termination of the iteration may be determined, and the temporary position coordinates obtained in the current iteration may be taken as the initial position coordinates of the positioning tag.

Otherwise, i.e., in a case where the absolute value of the difference value between the temporary position coordinates and the estimated position coordinates corresponding to the current iteration is greater than the preset first threshold, the case indicates that the temporary position of the positioning target obtained in the current iteration is far from the approximate position to which the positioning target may be moved estimated based on the historical position and the moving law of the positioning target, and at this time, it can be considered that the temporary position of the positioning target obtained in the current iteration is not accurate. Therefore, a set of signal arrival time differences that has never been selected may be selected from the plurality of sets of signal arrival time differences as a set of signal arrival time differences corresponding to a start of a next iteration, i.e., a set of signal arrival time differences that has never been selected may be selected from all the sets of signal arrival time differences for iterative computation again until the obtained temporary position is closer to the approximate position to which the positioning target may be moved estimated based on the historical position and the moving law of the positioning target.

In some embodiments, as previously described, when there is one initial positioning anchor and four responder positioning anchors, four response signals transmitted by the four responder positioning anchors may generate four response arrival timestamps, and four signal arrival time differences may be generated between these four response arrival timestamps and the initial arrival timestamp corresponding to the initial signal, and any two of these four signal arrival time differences may be combined, so that six sets of signal arrival time differences may be obtained: (αₘ; αₙ), (αₘ; αₚ), (αₘ; α_{q}), (αₙ; αₚ), (αₙ; α_{q}), (αₚ; α_{q}).

As mentioned earlier, when the set of signal arrival time differences selected at the start of the 1st iteration is (αₘ; αₙ), if the temporary position coordinates obtained in the current iteration do not meet the requirement, i.e., if the temporary position obtained in the current iteration deviates far from the approximate position to which the positioning target may be moved estimated based on the historical position and moving law of the positioning target, then a set of signal arrival time differences may be selected for next iterative computation, from five sets of signal arrival time differences in the above six sets of signal arrival time differences other than the set of signal arrival time differences (αₘ; αₙ) that has already been selected. And so on until the temporary position obtained from the iteration is closer to the estimated position corresponding to that iteration.

Since the moving speed of the positioning target is generally fixed and does not have large fluctuations, the approximate position to which the positioning target may be currently moved may be estimated based on the historical position and the moving speed of the positioning target, and the position obtained by the estimation may be used as a basis for judging whether the temporary position obtained by the current iteration is accurate. When the temporary position obtained in the current iteration is closer to the current estimated position, it means that the temporary position obtained in the current iteration is more in line with the moving law of the positioning target, and at this time, it may be considered that the credibility of the temporary position is higher; on the contrary, if the temporary position obtained in the current iteration is farther away from the current estimated position, it means that the temporary position obtained in the current iteration is not quite in line with the moving law of the positioning target, and at this time, it may be considered that the confidence of this temporary position is low, and it is necessary to re-select a set of signal arrival time differences for iterative calculation. In this way, a closed-loop feedback mechanism is formed in which the historical position of the positioning target in the historical process and the moving law act on the subsequent selection of the positioning anchor and the positioning calculation, which ensures that the initial position coordinates ultimately obtained are in line with the objective moving law of the positioning target and improves the overall positioning accuracy.

Chan algorithm may also be used to calculate the initial position coordinates of the positioning target:

(1) When the coordinates of the positioning target are (x, y), the coordinates of the positioning anchor i are (xᵢ, yᵢ), and the distance between the positioning anchor i and the positioning target is rt.

$${r}_{i} = \sqrt{{( {x}_{i} - x )}^{2} + {( {y}_{i} - y )}^{2}}$$

$${{r}_{i}}^{2} = {K}_{i} - 2 {x}_{i} x - 2 {y}_{i} y + {x}^{2} + {y}^{2}$$

$${r}_{i 0} = {r}_{i} - {r}_{0}$$

Here, r₀ may be the distance between the positioning target and the initial positioning anchor (x₀, y₀).

(2) When Kᵢ=xᵢ²+yᵢ², kᵢ=½(rᵢ₀+K₀−Kᵢ), the following may be got:

$$( {x}_{0} - {x}_{i} ) x + ( {y}_{0} - {y}_{i} ) y = {k}_{i} + {r}_{0} {r}_{i 0}$$

Here, K₀ is the value of Kᵢ at i=0.

(3) Its matrix expression may be shown as follows:

$$AX = F$$

$$A = [ \begin{matrix}{x}_{0} - {x}_{1} & {y}_{0} - {y}_{1} \\ {x}_{0} - {x}_{2} & {y}_{0} - {y}_{2}\end{matrix} ] X = [ \begin{matrix}x \\ y\end{matrix} ] F = [ \begin{matrix}{k}_{1} + {r}_{0} {r}_{10} \\ {k}_{2} + {r}_{0} {r}_{20}\end{matrix} ]$$

(4) The coordinate values of the positioning target may be obtained by solving the matrix equation:

$$X = {( {A}^{T} A )}^{- 1} {A}^{T} F$$

In operation 103, final position coordinates of the target position may be obtained by calculating based on the initial position coordinates, position coordinates of the initial positioning anchor, and position coordinates of the responder positioning anchor. Further, the final position coordinates of the target position may be obtained in an iterative method. The iteration algorithm may be Taylor iteration algorithm or other iteration algorithm. In a case where the iteration algorithm is Taylor iteration algorithm, the initial position coordinates obtained based on the signal arrival time difference may be used as the starting point of Taylor algorithm. During Taylor iteration process, the position of the positioning target may be estimated using maximum approximation estimation, and the iteration result is output when an iterative error is less than a threshold.

According to an exemplary embodiment of the disclosure, input position coordinates corresponding to the start of the current iteration may be determined. The input position coordinates corresponding to the start of the first iteration may be the above initial position coordinates.

Then, an iterative error w and an error compensation δ corresponding to the current iteration may be determined based on the input position coordinates corresponding to the start of the current iteration, the position coordinates of the initial positioning anchor, and the position coordinates of the responder positioning anchor:

(1) When the coordinate values of the positioning target satisfy the following equation fᵢ(x, y, xᵢ, yᵢ), and expand the equation in (xᵢₙᵢₜᵢₐₗ, yᵢₙᵢₜᵢₐₗ) with Taylor:

$${f}_{i} ( x , y , {x}_{i} , {y}_{i} ) = {f}_{i} ( {x}_{initial} , {y}_{initial} , {x}_{i} , {y}_{i} ) + ( Δ x \frac{\partial }{\partial x} + Δ y \frac{\partial }{\partial y} ) {f}_{i} ( {x}_{initial} , {y}_{initial} , {x}_{i} , {y}_{i} ) + {o}^{n}$$

$${f}_{i} ( x , y , {x}_{i} , {y}_{i} ) = c ( {t}_{i} - {t}_{1} ) = {R}_{i} - {R}_{1} = \sqrt{{( x - {x}_{i} )}^{2} + {( y - {y}_{i} )}^{2}} - \sqrt{{( x - {x}_{1} )}^{2} + {( y - {y}_{1} )}^{2}}$$

Here, (xᵢₙᵢₜᵢₐₗ, yᵢₙᵢₜᵢₐₗ) is the above “initial position coordinates”, Rᵢ is a distance between the positioning target and the positioning anchor i, R₁ is a distance between the positioning target and the positioning anchor 1, tᵢ is a flight time that the signal transmitted by the positioning anchor i reaches the positioning target, and t₁ is a flight time that the signal transmitted by the positioning anchor 1 reaches the positioning target.

(2) The coordinate model of the positioning target may be established:

$$ψ = {h}_{i} - {G}_{i} δ$$

$${h}_{i} = ( \begin{matrix}{R}_{2 , 1} - ( {R}_{2} - {R}_{1} ) \\ {R}_{3 , 1} - ( {R}_{3} - {R}_{1} ) \\ ⋮ \\ {R}_{N , 1} - ( {R}_{N} - {R}_{1} )\end{matrix} ) = ( \begin{matrix}\frac{{x}_{1} - x}{{R}_{1}} - \frac{{x}_{2} - x}{{R}_{2}} & \frac{{y}_{1} - y}{{R}_{1}} - \frac{{y}_{2} - y}{{R}_{2}} \\ \frac{{x}_{1} - x}{{R}_{1}} - \frac{{x}_{3} - x}{{R}_{3}} & \frac{{y}_{1} - y}{{R}_{1}} - \frac{{y}_{3} - y}{{R}_{3}} \\ ⋮ & ⋮ \\ \frac{{x}_{1} - x}{{R}_{1}} - \frac{{x}_{N} - x}{{R}_{N}} & \frac{{y}_{1} - y}{{R}_{1}} - \frac{{y}_{N} - y}{{R}_{N}}\end{matrix} ) δ = ( \begin{matrix}Δ x \\ Δ y\end{matrix} )$$

$$δ = [ \begin{matrix}Δ x \\ Δ y\end{matrix} ] = {( {G}_{i}^{T} {Q}^{- 1} {G}_{i} )}^{- 1} {G}_{i}^{T} {Q}^{- 1} {h}_{i}$$

Here, ψ represents the iterative error, i.e., the estimation error, Rᵢ (i=1, 2, 3, . . . , N) denotes a distance between the positioning target and the positioning anchor i, R_{N,1} denotes a distance between the positioning anchor N and the positioning anchor 1, (x_{N}, y_{N}) denotes the position coordinates of the positioning anchor N, and (x, y) denotes the above input position coordinates, and Q denotes a covariance matrix of the signal arrival time difference, Q may be pre-set according to the actual needs, and the previously set Q is always used without any change to Q. δ is the above “error compensation”, which may be used to correctly compensate for the estimated coordinates of the positioning target in the next iteration, i.e., the input position coordinates at the start of the next iteration may be determined based on the input position coordinates corresponding to the start of the current iteration and the error compensation δ obtained in the current iteration:

$${x}_{input}^{′} = {x}_{input} + Δ x , {y}_{input}^{′} = {y}_{input} + Δ y$$

Here, (xᵢₙₚᵤₜ′, yᵢₙₚᵤₜ′) are the input position coordinates corresponding to the start of the next iteration, and (xᵢₙₚᵤₜ, yᵢₙₚᵤₜ) are the input position coordinates corresponding to the start of the current iteration.

Next, whether the iteration is terminated may be determined based on the iterative error and a preset second threshold. The input position coordinates at the time of termination of the iteration may be determined as the final position coordinates.

According to an exemplary embodiment of the disclosure, in a case where the iterative error is less than or equal to the preset second threshold, the iteration may be determined to be terminated, and at this time, the input position coordinates at the time of termination of the iteration may be determined to be the final position coordinates of the positioning target; otherwise, i.e., in a case where the iterative error is greater than the preset second threshold, the input position coordinates at the start of the next iteration may be determined based on the error compensation obtained in the current iteration and the input position coordinates corresponding to the start of the current iteration, and thus the next Taylor iteration may be carried out until the iteration is terminated, i.e., until the obtained iterative error is less than or equal to the preset second threshold.

Taylor series utilizes a polynomial to be expanded at a fixed point to approximate the original function, i.e., Taylor expansion approximates the optimal solution through constant iterations, and the selection of the expansion point has an impact on the final result. When the iteration is carried out to the point where the error is within an acceptable range, the positioning result of the positioning target is output, which may ensure the positioning accuracy and precision.

Further, after obtaining the final position coordinates of the positioning tag through Taylor iteration, the obtained final position coordinates may also be filtered, which may realize correcting the output result of the iteration computation, removing the systematic error and improving the positioning accuracy, thereby solving the problem that Taylor algorithm may miss the optimal solution and fail to obtain a convergence result. In some embodiments, the filtering process may be performed based on the currently obtained final position coordinates and a plurality of historical final position coordinates obtained in a historical process. The filtering method may be a Kalman filtering method or other filtering methods.

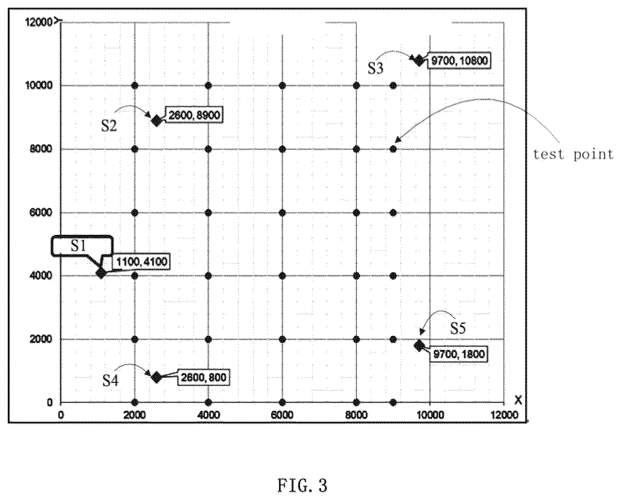

The disclosure also builds a simulation experiment system, which includes an initial positioning anchor and four responder positioning anchors. Moreover, 30 test points may be labeled in the test area, and 1000 sets of ultra-wideband message signals may be collected at each test point. FIG. 3 illustrates relative positions of a positioning anchor and a test point according to an exemplary embodiment of the disclosure. Referring to FIG. 3, the leftmost diamond pattern S1 indicates an initial positioning anchor (initiator), the other four diamond patterns S2, S3, S4, and S5 indicate responder positioning anchors, and the 30 dots in the diagram indicate 30 test points.

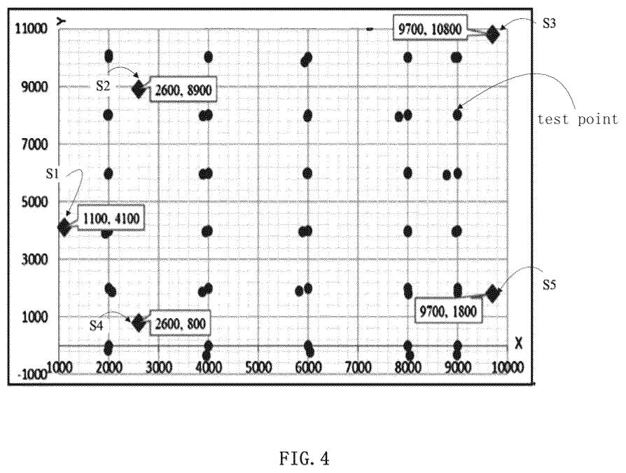

FIG. 4 illustrates a positioning result according to an exemplary embodiment of the disclosure. Referring to FIG. 4, each of 30 test points contains two dots at each test point, wherein one of the dots represents a positioning result obtained by positioning the test point using the positioning method of the disclosure, and the other dot represents a true position of the corresponding test point. It can be seen that the two dots at each test point either completely overlap, partially overlap, or are very close in position, which indicates that most of the positioning results coincide with the true position, and verifies the reliability and accuracy of the positioning method of the disclosure.

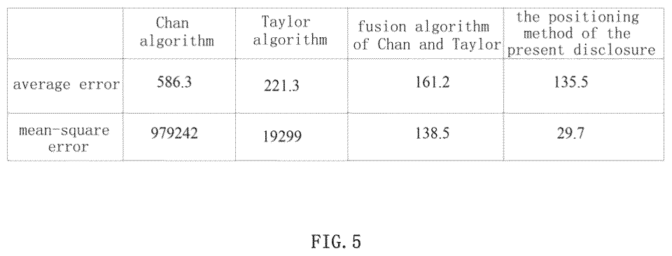

The smaller the average error is, the higher the average accuracy of the positioning is; and the smaller the mean square error is, the better the system stability is. FIG. 5 illustrates a comparison of positioning indicators of a positioning method of the disclosure with other positioning methods. Referring to FIG. 5, the average error of the positioning method of the disclosure is less than that of each of Chan algorithm, Taylor algorithm, and fusion algorithm (combination) of Chan algorithm and Taylor algorithm, i.e., the average accuracy of the positioning method of the disclosure is better than that of any one of the three algorithms; moreover, the mean-square error of the positioning method of the disclosure is less than that of each of Chan algorithm, Taylor algorithm, and fusion algorithm (combination) of Chan algorithm and Taylor algorithm, i.e., the system stability of the positioning method of the disclosure is superior to that of any one of the three algorithms.

With the development of modern industry, positioning systems of high precision are becoming increasingly important. The positioning method provided in the disclosure may be applied in many fields, for example, in indoor navigation, asset tracking, geo-fencing, intelligent parking, device detection and conflict avoidance.

The positioning method provided by the disclosure does not require time synchronization, thus the deployment cost of the positioning system is low and the positioning system is easy to be deployed. The positioning tag, i.e., the positioning tag, may perform position calculation by itself, which may realize the protection of the user's privacy as well as ensure the high capacity of the positioning system. Moreover, the positioning system provided by the disclosure has better robustness, higher stability, and higher accuracy than the positioning methods in the related art.

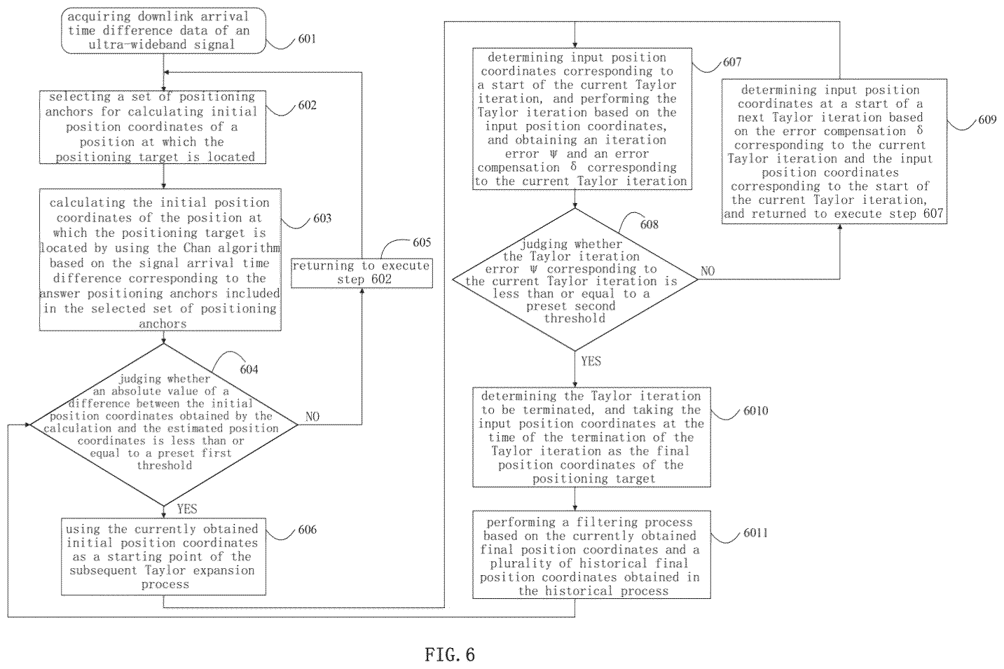

FIG. 6 illustrates a specific implementation of a positioning method according to an exemplary embodiment of the disclosure.

Referring to FIG. 6, in operation 601, downlink arrival time difference data of an ultra-wideband signal is acquired.

As described in the previous embodiment, the number of initial positioning anchors may be 1 and may be denoted by o. The number of responder positioning anchors may be set to 4, respectively, the responder positioning anchor m, the responder positioning anchor n, the responder positioning anchor p, and the responder positioning anchor q. The initial positioning anchor may periodically transmit an initial signal.

After the initial positioning anchor transmits the ultra-wideband signal once, the target tag may receive the ultra-wideband signal and may obtain an initial arrival time stamp of the ultra-wideband signal arriving at the target tag. Moreover, each of the four responder positioning anchors may also receive the ultra-wideband signal, and each responder positioning anchor may transmit a response signal after a certain delay in receiving the ultra-wideband signal. At this time, the target tag may receive four response signals transmitted by each of the four responder positioning anchors, and may obtain a response arrival time stamp of each of the four response signals arriving at the target tag.

Next, the target tag may obtain a time difference between the response arrival timestamp of each of the four response signals and the initial arrival timestamp of the initial signal, i.e., it may obtain four signal arrival time differences. When these four signal arrival time differences are a signal arrival time difference αₘ, a signal arrival time difference αₙ, a signal arrival time difference αₚ, a signal arrival time difference α_{g}, respectively, these four signal arrival time differences may generate six sets of signal arrival time differences, which are (αₘ; αₙ), (αₘ; αₚ), (αₘ; α_{q}), (αₙ; αₚ), (αₙ; α_{q}), (αₚ; α_{q}).

In operation 602, a set of positioning anchors for calculating initial position coordinates of a position at which the positioning target is located is selected.

As previously described, when the number of initial positioning anchors may be 1 and the number of responder positioning anchors may be 4, two responder positioning anchors may be selected from the four responder positioning anchors, and the initial position coordinates of the position at which the positioning target is located may be calculated using the signal arrival time difference corresponding to the two selected responder positioning anchors.

In operation 603, the initial position coordinates of the position at which the positioning target is located is calculated by using Chan algorithm, based on the signal arrival time difference corresponding to the responder positioning anchors included in the selected set of positioning anchors.

In operation 604, it is judged whether an absolute value of a difference between the initial position coordinates obtained by the calculation and the estimated position coordinates is less than or equal to a preset first threshold. The “estimated position coordinates” are the approximate position of the positioning target at the time of receiving the current ultra-wideband signal which is estimated based on the historical position of the positioning target during the historical process before receiving the current ultra-wideband signal and the moving law of the positioning target.

In operation 605, in a case where the judgment result is that the absolute value of the difference between the initial position coordinates obtained by the calculation and the estimated position coordinates is greater than the preset first threshold, operation 602 is returned to be executed, i.e., a set of positioning anchors for calculating the initial position coordinates of the position at which the positioning target is located may be re-selected, and the initial position coordinates of the position at which the positioning target is located are re-calculated based on the signal arrival time difference corresponding to the responder positioning anchors included in the re-selected set of positioning anchors, until the absolute value of the difference between the obtained initial position coordinates and the estimated position coordinates is less than or equal to the preset first threshold value. Moreover, the responder positioning anchors included in the re-selected set of positioning anchors are not identical each time.

In operation 606, in a case where the judgment result is that the absolute value of the difference between the initial position coordinates obtained by the calculation and the estimated position coordinates is less than or equal to the preset first threshold, the currently obtained initial position coordinates are used as a starting point of the subsequent Taylor expansion process.

In operation 607, input position coordinates corresponding to a start of the current Taylor iteration is determined, and Taylor iteration is performed based on the input position coordinates, and an iterative error y and an error compensation δ corresponding to the current Taylor iteration are obtained. Wherein the input position coordinates corresponding to the start of the first Taylor iteration is the above initial position coordinates.

In operation 608, it is judged whether Taylor iterative error y corresponding to the current Taylor iteration is less than or equal to a preset second threshold.

In operation 609, in a case where the judgment result is that Taylor iterative error y corresponding to the current Taylor iteration is greater than the preset second threshold, input position coordinates at a start of a next Taylor iteration are determined based on the error compensation δ corresponding to the current Taylor iteration and the input position coordinates corresponding to the start of the current Taylor iteration, and operation 607 is returned to be executed, until the obtained Taylor iterative error is less than or equal to the preset second threshold value.

In operation 6010, in a case where the judgment result is that Taylor iterative error y corresponding to the current Taylor iteration is less than or equal to the preset second threshold, Taylor iteration is determined to be terminated, and the input position coordinates at the time of the termination of Taylor iteration may be taken as the final position coordinates of the positioning target.

In operation 6011, a filtering process is performed based on the currently obtained final position coordinates and a plurality of historical final position coordinates obtained in the historical process. In this way, correcting the output result of Taylor iterative calculation, removing the systematic error, and improving the positioning accuracy may be realized.

Further, the final position coordinates of the positioning target obtained based on the current received ultra-wideband signal may also be used in the selection of the positioning anchor and the positioning calculation in the subsequent process, i.e., a closed-loop feedback mechanism may be formed, which may improve the overall positioning accuracy.

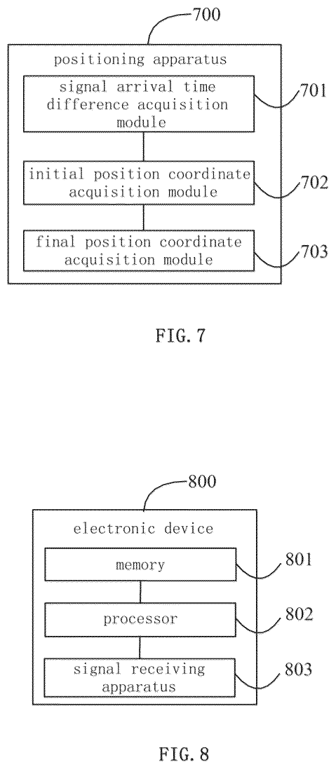

FIG. 7 illustrates a positioning apparatus according to an exemplary embodiment of the disclosure.

Referring to FIG. 7, the apparatus 700 may include a signal arrival time difference acquisition module 701 (or a signal arrival time difference acquisition circuit), an initial position coordinate acquisition module 702 (an initial position coordinate acquisition circuit), and a final position coordinate acquisition module 703 (a final position coordinate acquisition circuit).

The signal arrival time difference acquisition module 701 may acquire a signal arrival time difference. Wherein the signal arrival time difference may be a time difference between a response arrival time stamp at which a response signal transmitted by a responder positioning anchor reaches a target tag and an initial arrival time stamp at which an initial signal transmitted by an initial positioning anchor reaches the target tag. The response signal may be a signal generated to respond the initial signal by the responder positioning anchor after receiving the initial signal

In some embodiments, a number of initial positioning anchors may be set to 1 and may be represented by o. A number of responder positioning anchors may be set to 4, they are a responder positioning anchor m, a responder positioning anchor n, a responder positioning anchor p, and a responder positioning anchor q, respectively. The initial positioning anchor may periodically transmit an initial signal, i.e., it may transmit an ultra-wideband signal at a preset time interval. The preset time interval may be set arbitrarily according to actual needs.

After the initial positioning anchor transmits the ultra-wideband signal once, the target tag may receive the ultra-wideband signal and may obtain an initial arrival time stamp of the ultra-wideband signal arriving at the target tag. Moreover, each of the four responder positioning anchors may also receive the ultra-wideband signal, and each responder positioning anchor may transmit a response signal after a certain delay in receiving the ultra-wideband signal. At this time, the target tag may receive four response signals transmitted by each of the four responder positioning anchors, and may obtain a response arrival time stamp of each of the four response signals arriving at the target tag.

Next, the target tag may obtain a time difference between the response arrival timestamp of each of the four response signals and the initial arrival timestamp of the initial signal, i.e., it may obtain four signal arrival time differences. when these four signal arrival time differences are a signal arrival time difference αₘ, a signal arrival time difference αₙ, a signal arrival time difference αₚ, a signal arrival time difference α_{g}, respectively, these four signal arrival time differences may generate six sets of signal arrival time differences, which are (αₘ; αₙ), (αₘ; αₚ), (αₘ; α_{q}), (αₙ; αₚ), (αₙ; α_{q}), (αₚ; α_{q}).

The initial position coordinate acquisition module 702 may acquire initial position coordinates of a target position at which the target tag is located based on the signal arrival time difference.

According to an exemplary embodiment of the disclosure, the signal arrival time difference may include a plurality of signal arrival time differences. In some embodiments, as previously described, a total of 4 responder positioning anchors may exist, 4 signal arrival time differences may be obtained accordingly, the signal arrival time difference αₘ, the signal arrival time difference αₙ, the signal arrival time difference αₚ, the signal arrival time difference α_{g}, respectively. The initial position coordinates may be obtained in an iterative way based on the plurality of signal arrival time differences. In some embodiments, the initial position coordinates (x, y) of the positioning tag may be obtained in the iterative way based on four signal arrival time differences.

For each iterative process, the initial position coordinate acquisition module 702 may perform the following operations:

The initial position coordinate acquisition module 702 may determine a set of signal arrival time differences corresponding to a start of the current iteration. The set of signal arrival time differences is one of a plurality of sets of signal arrival time differences obtained by combining any two of the plurality of signal arrival time differences. In some embodiments, the set of signal arrival time differences corresponding to the start of the current iteration may be determined to be (αₘ; αₙ), and the set of signal arrival time differences (αₘ; αₙ) is one of the six sets of signal arrival time differences (αₘ; αₙ), (αₘ; αₚ), (αₘ; α_{q}), (αₙ; αₚ), (αₙ; α_{q}), (αₚ; α_{q}).

Then, the initial position coordinate acquisition module 702 may acquire temporary position coordinates of the target position based on two signal arrival time differences contained in the set of the corresponding signal arrival time differences at the start of the current iteration. In some embodiments, the temporary position coordinates of the target position may be obtained based on the set of the signal arrival time differences (αₘ; αₙ) corresponding to the start of the current iteration, the position coordinates (xₒ; yₒ) of the initial positioning anchor o, the position coordinates (xₘ; yₘ) of the responder positioning anchor m, the response delay βₘ corresponding to the responder positioning anchor m, the position coordinates (xₙ; yₙ) of the responder positioning anchor n, the response delay βₙ corresponding to the responder positioning anchor n.

Next, the initial position coordinate acquisition module 702 may acquire estimated position coordinates corresponding to the current iteration based on the initial arrival time stamp, a historical initial arrival time stamp, a preset moving speed, and historical final position coordinates. The historical initial arrival time stamp is a time stamp of a last historical initial signal arriving at the target tag before the initial signal arrives at the target tag, and the historical final position coordinates are coordinates of a position at which the target tag is located during the course of history that are acquired based on the historical initial signal.

Then, the initial position coordinate acquisition module 702 may determine whether the iterative process is terminated based on the temporary position coordinates and the estimated position coordinates corresponding to the current iteration. The temporary position coordinates obtained when the iteration is terminated may be determined as the initial position coordinates. In this way, the initial position coordinates may be calculated in the iterative way, i.e., the set of positioning anchors may be adaptively selected, i.e., the initial position coordinates may be calculated by using a greater number of signal arrival time differences, the accuracy of the calculation of the initial position coordinates may be corrected, and the problem that the mathematical formula of Chan algorithm may be unsolvable in some cases may be solved.

According to an exemplary embodiment of the disclosure, the initial position coordinate acquisition module 702 may determine a timestamp difference value between an initial arrival timestamp and a historical initial arrival timestamp. In some embodiments, the initial positioning anchor may periodically transmit an initial signal, and the positioning tag may determine a time difference between the initial arrival timestamp of the current received initial signal (i.e., the timestamp of the initial signal transmitted by the initial positioning anchor arriving at the positioning tag this time) and the historical initial arrival timestamp of the historical initial signal received prior to this time (i.e., the time stamp of the initial signal transmitted by the initial positioning anchor arriving at the positioning tag last time) based on the initial arrival timestamp and the historical initial arrival timestamp.

Then, the initial position coordinate acquisition module 702 may estimate a moving distance of the target tag based on the time stamp difference value and the preset moving speed. That is, the initial position coordinate acquisition module 702 may estimate an approximate distance moved by the target tag within the time interval between two received initial signals based on the time difference between the two received initial signals and the pre-stored moving speed of the positioning target.

Next, the initial position coordinate acquisition module 702 may determine the estimated position coordinates corresponding to the current iteration based on the above moving distance and the historical final position coordinates. That is, the initial position coordinate acquisition module 702 may estimate an approximate position to which the positioning target is moved when the initial signal is received this time based on the estimated approximate distance moved by the positioning target within the time interval between the two received initial signals and the final position coordinates of the positioning target determined last time.

Further, in different scenarios, the preset moving speed may be different. For example, in a scenario in which the positioning is performed for a car, the preset moving speed is a normal traveling speed of the car, which may be set relatively large; in a scenario in which the positioning is performed for a natural person, the preset moving speed is a normal walking speed of the natural person, which may be set relatively small. It can be seen that the preset moving speed in different scenarios is related to a type of a positioning target in the scenario. In this way, the disclosure may provide a feedback mechanism that may feed the current positioning result into the next positioning calculation, forming a closed-loop feedback system that may improve the overall positioning accuracy.

According to an exemplary embodiment of the disclosure, in a case where an absolute value of a difference value between the temporary position coordinates and the estimated position coordinates corresponding to the current iteration is less than or equal to a preset first threshold, it indicates that the temporary position of the positioning target obtained in the current iteration is closer to the approximate position to which the positioning target may be moved estimated based on the historical position and the moving law of the positioning target, and at this time, the initial position coordinate acquisition module 702 may consider that the temporary position of the positioning target obtained in the current iteration is more accurate. Therefore, the termination of the iteration may be determined, and the temporary position coordinates obtained in the current iteration may be taken as the initial position coordinates of the positioning tag.

Otherwise, i.e., in a case where the absolute value of the difference value between the temporary position coordinates and the estimated position coordinates corresponding to the current iteration is greater than the preset first threshold, it indicates that the temporary position of the positioning target obtained in the current iteration is far from the approximate position to which the positioning target may be moved estimated based on the historical position and the moving law of the positioning target, and at this time, the initial position coordinate acquisition module 702 may consider that the temporary position of the positioning target obtained in the current iteration is not accurate. Therefore, the initial position coordinate acquisition module 702 may select a set of signal arrival time differences that has never been selected from the plurality of sets of signal arrival time differences as a set of signal arrival time differences corresponding to a start of a next iteration, i.e., may select a set of signal arrival time differences that has never been selected from all the sets of signal arrival time differences for iterative computation again until the obtained temporary position is closer to the approximate position to which the positioning target may be moved estimated based on the historical position and the moving law of the positioning target.

In some embodiments, as previously described, when there is one initial positioning anchor and four responder positioning anchors, four response signals transmitted by the four responder positioning anchors may generate four response arrival timestamps, and four signal arrival time differences may be generated between these four response arrival timestamps and the initial arrival timestamp corresponding to the initial signal, and any two of these four signal arrival time differences may be combined, so that six sets of signal arrival time differences may be obtained: (αₘ; αₙ), (αₘ; αₚ), (αₘ; α_{q}), (αₙ; αₚ), (αₙ; α_{q}), (αₚ; α_{q}).

As mentioned earlier, the set of signal arrival time differences selected at the start of the 1st iteration is (αₘ; αₙ), if the temporary position coordinates obtained in the current iteration do not meet the requirement, i.e., if the temporary position obtained in the current iteration deviates far from the approximate position to which the positioning target may be moved estimated based on the historical position and moving law of the positioning target, then a set of signal arrival time differences may be selected for next iterative computation, from five sets of signal arrival time differences in the above six sets of signal arrival time differences other than the set of signal arrival time differences (αₘ; αₙ) that has already been selected. And so on until the temporary position obtained from the iteration is closer to the estimated position corresponding to that iteration.

Since the moving speed of the positioning target is generally fixed and does not have large fluctuations, the approximate position to which the positioning target may be currently moved may be estimated based on the historical position and the moving speed of the positioning target, and the position obtained by the estimation may be used as a basis for judging whether the temporary position obtained by the current iteration is accurate. When the temporary position obtained in the current iteration is closer to the current estimated position, it means that the temporary position obtained in the current iteration is more in line with the moving law of the positioning target, and at this time, it may be considered that the credibility of the temporary position is higher; on the contrary, if the temporary position obtained in the current iteration is farther away from the current estimated position, it means that the temporary position obtained in the current iteration is not quite in line with the moving law of the positioning target, and at this time, it may be considered that the confidence of this temporary position is low, and it is necessary to re-select a set of signal arrival time differences for iterative calculation. In this way, a closed-loop feedback mechanism is formed in which the historical position of the positioning target in the historical process and the moving law act on the subsequent selection of the positioning anchor and the positioning calculation, which ensures that the initial position coordinates ultimately obtained are in line with the objective moving law of the positioning target and improves the overall positioning accuracy.

The final position coordinate acquisition module 703 may obtain final position coordinates of the target position by calculating based on the initial position coordinates, position coordinates of the initial positioning anchor and position coordinates of the responder positioning anchor. Further, the final position coordinate acquisition module 703 may obtain the final position coordinates of the target position in an iterative method. The iteration algorithm may be Taylor iteration algorithm or other iteration algorithm. In a case where the iteration algorithm is Taylor iteration algorithm, the initial position coordinates obtained based on the signal arrival time difference may be used as the starting point of Taylor algorithm. During Taylor iteration process, the position of the positioning target may be estimated using maximum approximation estimation, and the iteration result is output when an iterative error is less than a threshold.

According to an exemplary embodiment of the disclosure, the final position coordinate acquisition module 703 may determine input position coordinates corresponding to the start of the current iteration. The input position coordinates corresponding to the start of the first iteration may be the above initial position coordinates.

Then, the final position coordinate acquisition module 703 may determine an iterative error w and an error compensation δ corresponding to the current iteration based on the input position coordinates corresponding to the start of the current iteration, the position coordinates of the initial positioning anchor, and the position coordinates of the responder positioning anchor.

Next, the final position coordinate acquisition module 703 may determine whether the iteration is terminated based on the iterative error and a preset second threshold. The input position coordinates at the time of termination of the iteration may be determined as the final position coordinates.

According to an exemplary embodiment of the disclosure, in a case where the iterative error is less than or equal to the preset second threshold, the final position coordinate acquisition module 703 may determine the iteration to be terminated, and at this time, the final position coordinate acquisition module 703 may determine the input position coordinates at the time of termination of the iteration to be the final position coordinates of the positioning target; otherwise, i.e., in a case where the iterative error is greater than the preset second threshold, the final position coordinate acquisition module 703 may determine the input position coordinates at the start of the next iteration based on the error compensation obtained in the current iteration and the input position coordinates corresponding to the start of the current iteration, and thus may carry out the next Taylor iteration until the iteration is terminated, i.e., until the obtained iterative error is less than or equal to the preset second threshold.

Taylor series utilizes a polynomial to be expanded at a fixed point to approximate the original function, i.e., Taylor expansion approximates the optimal solution through constant iterations, and the selection of the expansion point has an impact on the final result. When the iteration is carried out to the point where the error is within an acceptable range, the positioning result of the positioning target is output, which may ensure the positioning accuracy and precision.

Further, after obtaining the final position coordinates of the positioning tag through Taylor iteration, the obtained final position coordinates may also be filtered, which may realize correcting the output result of the iteration computation, removing the systematic error and improving the positioning accuracy, thereby solving the problem that Taylor algorithm may miss the optimal solution and fail to obtain a convergence result. In some embodiments, the filtering process may be performed based on the currently obtained final position coordinates and a plurality of historical final position coordinates obtained in a historical process. The filtering method may be a Kalman filtering method or other filtering methods.

FIG. 8 illustrates an electronic device 800 according to an exemplary embodiment of the disclosure.

Referring to FIG. 8, the electronic device 800 includes at least one memory 801, at least one processor 802 and a signal receiving apparatus 803, the at least one memory 801 has instructions stored therein, which, when executed by the at least one processor 802, execute the above instructions based on a signal received by the signal receiving apparatus, to implement a positioning method according to an exemplary embodiment of the disclosure.

As an example, the electronic device 800 may be a PC computer, a tablet device, a personal digital assistant, a smart phone, or any other device capable of executing the above instructions. Here, the electronic device 800 does not have to be a single electronic device, but may also be any set of devices or circuits capable of executing the above instructions (or instruction set) individually or jointly. The electronic device 800 may also be a part of an integrated control system or system manager, or may be configured as a portable electronic device that interfaces locally or remotely (e.g., via wireless transmission).

In the electronic device 800, the at least one processor 802 may include a central processing unit (CPU), a graphics processor (GPU), a programmable logic device, a dedicated processor system, a microcontroller, or a microprocessor. By way of example and not limitation, the at least one processor 802 may also include an analog processor, a digital processor, a microprocessor, a multi-core processor, a processor array, a network processor, and the like.

The at least one processor 802 may run instructions or code stored in the at least one memory 801, wherein the at least one memory 801 may also store data. The instructions and data may also be sent and received over a network via a network interface device, wherein the network interface device may utilize any known transmission protocol.

The at least one memory 801 may be integrated with the at least one processor 802, e.g., a random access memory (RAM) or flash memory is arranged within an integrated circuit microprocessor or the like. Additionally, the at least one memory 801 may include a separate device such as an external disk drive, storage array, or any other storage device that may be used by a database system. The at least one memory 801 and the at least one processor 802 may be operatively coupled, or may communicate with each other, e.g., through I/O ports, network connections, etc., to enable the at least one processor 802 to read files stored in the at least one memory 801.

In addition, the electronic device 800 may also include video displays (e.g. liquid crystal display) and user interaction interfaces (e.g. keyboard, mouse, touch input device, etc.). All components of the electronic device 800 may be connected to each other via a bus and/or a network.

According to an exemplary embodiment of the disclosure, a computer readable storage medium is also provided. Instructions in the computer readable storage medium, when executed by a processor of an electronic device, cause the processor to perform the above positioning method. Examples of computer-readable storage media herein include: Read Only Memory (ROM), Random Access Programmable Read Only Memory (RAPROM), Electrically Erasable Programmable Read Only Memory (EEPROM), RAM, Dynamic Random Access Memory (DRAM), Static Random Access Memory (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blue-ray or optical disk storage, Hard Disk Drive (HDD), Solid State Drive (SSD), card storage (such as multimedia cards, secure digital (SD) cards or extremely fast digital (XD) cards), magnetic tapes, floppy disks, magneto-optical data storage devices, optical data storage devices, hard disks, solid state disks, and any other devices that are configured to store computer programs and any associated data, data files and data structures in a non-transitory manner and provide the computer programs and any associated data, data files and data structures to a processor or computer so that the processor or computer can execute the computer programs. The instructions or computer programs in the computer-readable storage medium described above may be executed in an environment deployed in a computer device. In addition, in one example, the computer programs and any associated data, data files, and data structures are distributed on a networked computer system, so that the computer programs and any associated data, data files, and data structures are stored, accessed and executed through one or more processors or computers in a distributed manner.

The positioning method, the apparatus, the electronic device and the storage medium of the disclosure may first obtain the initial position coordinates of the target tag based on the signal arrival time difference, and then may obtain the final position coordinates of the target tag based on the calculation of the initial position coordinates and relevant parameters. That is, the disclosure does not require the time synchronization between the positioning anchors and between the positioning anchor and positioning target, which reduces the cost of system deployment and avoids additional overhead of signal transmission. Moreover, by means of iterative calculation, a gradual approximation of the optimal solution of the position coordinates may be realized, which may ensure the accuracy and precision of the positioning.

Further, the initial position coordinates may be calculated in the iterative way, i.e., the set of positioning anchors may be adaptively selected, i.e., the initial position coordinates may be calculated by using a greater number of signal arrival time differences, the accuracy of the calculation of the initial position coordinates may be corrected, and the problem that the mathematical formula of Chan algorithm may be unsolvable in some cases may be solved.

Further, the disclosure may provide a feedback mechanism that may feed the current positioning result into the next positioning calculation, forming a closed-loop feedback system that may improve the overall positioning accuracy.

Further, a closed-loop feedback mechanism is formed in which the historical position in which the positioning target was located in the historical process and the moving law act on the subsequent selection of the positioning anchor and the subsequent positioning calculation, which ensures that the initial position coordinates ultimately obtained are in line with the objective moving law of the positioning target and improves the overall positioning accuracy.

Further, Taylor series utilizes a polynomial to be expanded at a fixed point to approximate the original function, i.e., Taylor expansion approximates the optimal solution through constant iterations, and the selection of the expansion point has an impact on the final result. When the iteration is carried out to the point where the error is within an acceptable range, the positioning result of the positioning target is output, which may ensure the positioning accuracy and precision.

Further, after obtaining the final position coordinates of the positioning tag through Taylor iteration, the obtained final position coordinates may also be filtered, which may realize correcting the output result of the iteration computation, removing the systematic error and improving the positioning accuracy, thereby solving the problem that Taylor algorithm may miss the optimal solution and fail to obtain a convergence result.

Further, the positioning method provided by the disclosure does not require time synchronization, thus the deployment cost of the positioning system is low and the positioning system is easy to be deployed. The positioning tag, i.e., the positioning tag, may perform position calculation by itself, which may realize the protection of the user's privacy as well as ensure the high capacity of the positioning system. Moreover, the positioning system provided by the disclosure has better robustness, higher stability, and higher accuracy with respect to the positioning methods in the related art.

After considering the specification and the practice of the invention disclosed herein, those skilled in the art will readily conceive of other implementations of the disclosure. The disclosure is intended to cover any variation, use or adaptation of the disclosure that follows the general principles of the disclosure and includes the common knowledge or customary technical means in the field of technology not disclosed by the disclosure. The specification and embodiments are deemed to be exemplary only, and the true scope and spirit of the disclosure are indicated by the appended claims.

The disclosure is not limited to the precise structure already described above and shown in the attached drawings and is subject to various modifications and changes within its scope. The scope of the disclosure is limited only by the attached claims.

The embodiments may be described and illustrated in terms of blocks, as shown in the drawings, which carry out a described function or functions. These blocks, which may be referred to herein as the signal arrival time difference acquisition module 701, the initial position coordinate acquisition module 702, and the final position coordinate acquisition module 703 or the like may be physically implemented by analog and/or digital circuits including one or more of a logic gate, an integrated circuit, a microprocessor, a microcontroller, a memory circuit, a passive electronic component, an active electronic component, an optical component, and the like, and may also be implemented by or driven by software and/or firmware (configured to perform the functions or operations described herein). The circuits may, for example, be embodied in one or more semiconductor chips, or on substrate supports such as printed circuit boards and the like. Circuits included in a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks. Likewise, the blocks of the embodiments may be physically combined into more complex blocks.

What is claimed is:

1. A positioning method comprising:
acquiring a signal arrival time difference,
wherein the signal arrival time difference is a time difference between a response arrival time stamp at which a response signal transmitted by a responder positioning anchor reaches a target tag, and an initial arrival time stamp at which an initial signal transmitted by an initial positioning anchor reaches the target tag, and
wherein the response signal is a signal generated to respond the initial signal by the responder positioning anchor after receiving the initial signal;
acquiring, based on the signal arrival time difference, initial position coordinates of a target position at which the target tag is located; and
obtaining final position coordinates of the target position based on the initial position coordinates, position coordinates of the initial positioning anchor and position coordinates of the responder positioning anchor.

2. The positioning method of claim 1, wherein the signal arrival time difference comprises a plurality of signal arrival time differences,
wherein, based on the signal arrival time difference, the acquiring the initial position coordinates of the target position at which the target tag is located comprises acquiring the initial position coordinates in iterative operations, based on the plurality of signal arrival time differences, and
wherein, for each of the iterative operations, the position method further comprises:
determining a set of signal arrival time differences corresponding to a start of a current iteration, wherein the set of signal arrival time differences is one of a plurality of sets of signal arrival time differences obtained by combining any two of the plurality of signal arrival time differences;
acquiring temporary position coordinates of the target position based on two signal arrival time differences contained in the set of signal arrival time differences corresponding to the start of the current iteration;
acquiring estimated position coordinates corresponding to the current iteration based on the initial arrival time stamp, a historical initial arrival time stamp, a preset moving speed, and historical final position coordinates, wherein the historical initial arrival time stamp is a time stamp of a historical initial signal arriving at the target tag before the initial signal arrives at the target tag, and wherein the historical final position coordinates are coordinates of a position at which the target tag is located during a course of a history that is acquired based on the historical initial signal; and
determining whether the iterative operations are terminated based on the temporary position coordinates and the estimated position coordinates corresponding to the current iteration, wherein temporary position coordinates obtained based on the iterative operations being terminated are determined to be the initial position coordinates.

3. The positioning method of claim 2, wherein the determining whether the iterative operations are terminated based on the temporary position coordinates and the estimated position coordinates corresponding to the current iteration comprises:
determining that the iterative operations are terminated, based on an absolute value of a difference between the temporary position coordinates and the estimated position coordinates corresponding to the current iteration being smaller than or equal to a preset first threshold; and
selecting, from the plurality of sets of signal arrival time differences, a set of signal arrival time differences, which is not selected as a set of signal arrival time differences corresponding to a start of a next iteration, based on the absolute value of the difference between the temporary position coordinates and the estimated position coordinates corresponding to the current iteration being greater than the preset first threshold.

4. The positioning method of claim 1, wherein the obtaining final position coordinates of the target position based on the initial position coordinates, the position coordinates of the initial positioning anchor and the position coordinates of the responder positioning anchor comprises:
determining input position coordinates corresponding to a start of a current iteration, wherein the input position coordinates are the initial position coordinates;
determining an iterative error and an error compensation corresponding to the current iteration based on the input position coordinates corresponding to the start of the current iteration, the position coordinates of the initial positioning anchor, and the position coordinates of the responder positioning anchor; and
determining whether the iterative operations are terminated based on the iterative error and a preset second threshold, wherein input position coordinates based on the iterative operations being terminated are determined as the final position coordinates.

5. The positioning method of claim 4, wherein the determining whether the iterative operations are terminated based on the iterative error and the preset second threshold comprises:
determining that the iterative operations are terminated based on the iterative error being smaller than or equal to the preset second threshold; and
determining the input position coordinates at a start of a next iteration based on the error compensation and the input position coordinates corresponding to the start of the current iteration based on the iterative error being greater than the preset second threshold.

6. The positioning method of claim 2, wherein the acquiring the estimated position coordinates corresponding to the current iteration based on the initial arrival time stamp, the historical initial arrival time stamp, the preset moving speed, and the historical final position coordinates comprises:
determining a timestamp difference between an initial arrival timestamp and a historical initial arrival timestamp;
estimating a moving distance of the target tag based on the timestamp difference and the preset moving speed; and
determining the estimated position coordinates corresponding to the current iteration based on the moving distance and the historical final position coordinates.

7. A positioning apparatus comprising:
a signal arrival time difference acquisition module configured to acquire a signal arrival time difference,
wherein the signal arrival time difference is a time difference between a response arrival time stamp at which a response signal transmitted by a responder positioning anchor reaches a target tag, and an initial arrival time stamp at which an initial signal transmitted by an initial positioning anchor reaches the target tag, and
wherein the response signal is generated to respond the initial signal by the responder positioning anchor after receiving the initial signal;
an initial position coordinate acquisition module configured to acquire, based on the signal arrival time difference, initial position coordinates of a target position at which the target tag is located; and
a final position coordinate acquisition module configured to obtain final position coordinates of the target position based on the initial position coordinates, position coordinates of the initial positioning anchor and position coordinates of the responder positioning anchor.

8. The positioning apparatus of claim 7, wherein the signal arrival time difference comprises a plurality of signal arrival time differences,
wherein the initial position coordinate acquisition module is further configured to acquire the initial position coordinates in iterative operations based on the plurality of signal arrival time differences; and
wherein, for each of the iterative operations, the positioning apparatus is configured to:
determine a set of signal arrival time differences corresponding to a start of a current iteration, wherein the set of signal arrival time differences is one of a plurality of sets of signal arrival time differences obtained by combining any two of the plurality of signal arrival time differences;
acquire temporary position coordinates of the target position based on two signal arrival time differences contained in the set of signal arrival time differences corresponding to the start of the current iteration;
acquire estimated position coordinates corresponding to the current iteration, based on the initial arrival time stamp, a historical initial arrival time stamp, a preset moving speed, and historical final position coordinates, wherein the historical initial arrival time stamp is a time stamp of a historical initial signal arriving at the target tag before the initial signal arrives at the target tag, and the historical final position coordinates are coordinates of a position at which the target tag is located during a course of a history that is acquired based on the historical initial signal; and
determine whether the iterative operations are terminated, wherein temporary position coordinates obtained based on the iterative operations being terminated are determined to be the initial position coordinates.

9. The positioning apparatus of claim 8, wherein the initial position coordinate acquisition module is further configured to:
determine that the iterative operations are terminated, based on an absolute value of a difference between the temporary position coordinates and the estimated position coordinates corresponding to the current iteration being smaller than or equal to a preset first threshold; and
select, from the plurality of sets of signal arrival time differences, a set of signal arrival time differences, which is not selected as a set of signal arrival time differences corresponding to a start of a next iteration, based on the absolute value of the difference between the temporary position coordinates and the estimated position coordinates corresponding to the current iteration being greater than the preset first threshold.

10. The positioning apparatus of claim 7, wherein the final position coordinate acquisition module is further configured to:
determine input position coordinates corresponding to a start of a current iteration, wherein the input position coordinates corresponding to a start of a first iteration are the initial position coordinates;
determine an iterative error and an error compensation corresponding to the current iteration based on the input position coordinates corresponding to the start of the current iteration, the position coordinates of the initial positioning anchor, and the position coordinates of the responder positioning anchor; and
determine whether the iterative operations are terminated based on the iterative error and a preset second threshold, wherein the input position coordinates obtained based on the iterative operations being terminated are determined as the final position coordinates.

11. The positioning apparatus of claim 10, wherein the final position coordinate acquisition module is further configured to:
determine that the iterative operations are terminated based on the iterative error being smaller than or equal to the preset second threshold; and
determine the input position coordinates at a start of a next iteration based on the error compensation and the input position coordinates corresponding to the start of the current iteration, based on the iterative error being greater than the preset second threshold.

12. The positioning apparatus of claim 8, wherein the initial position coordinate acquisition module is further configured to:
determine a timestamp difference between an initial arrival timestamp and a historical initial arrival timestamp;
estimate a moving distance of the target tag based on the timestamp difference and the preset moving speed; and
determine the estimated position coordinates corresponding to the current iteration based on the moving distance and the historical final position coordinates.

13. An electronic device comprising:
a signal receiving apparatus;
a processor; and
a memory for storing instructions executable by the processor,
wherein the processor is configured to execute the instructions, based on a signal received by the signal receiving apparatus, to implement a positioning method as claimed in claim 1.

14. A computer readable storage medium, wherein instructions stored in the computer readable storage medium, when executed by a processor of an electronic device, cause the electronic device to perform a positioning method of claim 1.
